(19) United States
(12) Patent Application Publication
(10) Pub. No.: US 2019/0067685 A1
(43) Pub. Date: Feb. 28, 2019

(54) NEGATIVE ELECTRODE SLURRY, NEGATIVE ELECTRODE PLATE AND ELECTROCHEMICAL ENERGY STORAGE DEVICE

(71) Applicant: CONTEMPORARY AMPEREX TECHNOLOGY CO., LIMITED, Ningde (CN)

(72) Inventors: Zhongsi Zhu, Ningde (CN); Ze Zhong, Ningde (CN); Chengdong Sun, Ningde (CN); Yi Zheng, Ningde (CN); Lingyun Feng, Ningde (CN); Hang Zhou, Ningde (CN); Long Wang, Ningde (CN)

(21) Appl. No.: 16/047,985

(22) Filed: Jul. 27, 2018

(30) Foreign Application Priority Data
Aug. 31, 2017 (CN) 201710771572.3

(51) Int. Cl. H01M 4/36; H01M 4/583; H01M 4/62; H01M 10/0525; H01G 11/38; H01G 11/70

(52) U.S. Cl. CPC H01M 4/364; H01M 4/366; H01M 4/583; H01M 2004/027; H01M 10/0525; H01G 11/38; H01G 11/70; H01M 4/622

(57) ABSTRACT

The present disclosure provides a negative electrode slurry, a negative electrode plate and an electrochemical energy storage device. The negative electrode slurry comprises a solvent and a solid component dispersed in the solvent. The solid component comprises a negative electrode active material, a water-soluble binder and a dispersant. The negative electrode active material comprises a carbon-type active material. The dispersant comprises an A dispersant and a B dispersant, the A dispersant is a cellulose-type dispersant, the B dispersant is at least one of poly(acrylic acid)-type dispersant, polyacrylate-type dispersant and polyacrylamide-type dispersant. Under a combined effect of the A dispersant and the B dispersant, they can ensure that the electrochemical energy storage device has excellent dynamic performance, which can prevent lithium (or sodium, magnesium and zinc) from precipitating under condition of rapid and large current charging, meanwhile they can ensure that the electrochemical energy storage device has excellent cycle performance.

### CROSS-REFERENCE TO RELATED APPLICATIONS

The present application claims priority to Chinese patent application No. CN201710771572.3, filed on Aug. 31, 2017, which is incorporated herein by reference in its entirety.

### FIELD OF THE PRESENT DISCLOSURE

The present disclosure relates to the field of energy storage device, and more specifically relates to a negative electrode slurry, a negative electrode plate and an electrochemical energy storage device.

### BACKGROUND OF THE PRESENT DISCLOSURE

Lithium-ion battery is widely used in fields of consumer battery, power battery, energy storage battery and the like due to its high working voltage, large specific capacity, small self-discharge, long cycling life, no memory effect and environmental friendliness. Demands for high capacity and short charging time of the consumer battery and the power battery are increasing, the high capacity requires the battery to have high energy density, and the short charging time requires the battery to be rapidly charged with a large current, and large current charging requires a higher stability of materials such as a negative electrode active material, an electrolyte and a binder during charging and discharging.

The binder, as a composition of the battery, plays a role of improving electrochemical performance of the battery. To a battery system which has high demands on energy density and charging time, its negative electrode plate often uses water-soluble binder such as SBR-type polymer, styrene-acrylic-type polymer and acrylic-type polymer, they can effectively improve dynamic performance in precipitation lithium, rate capability and impedance. In order to further improve dynamic performance in rate capability and precipitation lithium of the battery, sodium carboxymethylcellulose can be replaced by polyacrylate polymer as a dispersant, however if polyacrylate polymer is used as the dispersant alone, when the charged-discharged cycle process is performed under low temperature and little electrolyte retention capability, capacity retention rate decreases quickly, and the battery will dive too early and cycle performance cannot meet the demands for use.

### SUMMARY OF THE PRESENT DISCLOSURE

In view of the problem existing in the background, an object of the present disclosure is to provide a negative electrode slurry, a negative electrode plate and an electrochemical energy storage device, the negative electrode slurry can improve dynamic performance and cycle performance of the electrochemical energy storage device at the same time.

In order to achieve the above object, in a first aspect of the present disclosure, the present disclosure provides a negative electrode slurry, which comprises a solvent and a solid component dispersed in the solvent. The solid component comprises a negative electrode active material, a water-soluble binder and a dispersant. The negative electrode active material comprises carbon-type active material. The dispersant comprises an A dispersant and a B dispersant, the A dispersant is a cellulose-type dispersant, the B dispersant is at least one of poly(acrylic acid)-type dispersant, polyacrylate-type dispersant and polyacrylamide-type dispersant.

In a second aspect of the present disclosure, the present disclosure provides a negative electrode plate, which comprises a negative electrode current collector and a negative electrode active material layer provided on a surface of the negative electrode current collector, the negative electrode active material layer is formed by that the negative electrode slurry according to the first aspect of the present disclosure is coated on the negative electrode current collector and dried.

In a third aspect of the present disclosure, the present disclosure provides an electrochemical energy storage device, which comprises the negative electrode plate according to the second aspect of the present disclosure.

Compared to the technology in the background, the present disclosure has the following beneficial effects: the negative electrode slurry according to the present disclosure comprises the negative electrode active material comprising the carbon-type active material, the A dispersant and the B dispersant, the A dispersant can form a protective film on a surface of the negative electrode active material, thereby avoiding a harmful effect of making a SEI film unstable because an unstable carboxylate formed by the B dispersant and an electrolyte salt will be left on the SEI film when the B dispersant is used alone, thus the A dispersant can improve cycle performance of the electrochemical energy storage device and prevent a cycling capacity of the electrochemical energy storage device from diving too early, and the B dispersant can improve dynamic performance of the electrochemical energy storage device, under a combined effect of the A dispersant and the B dispersant, on one hand, they can ensure that the electrochemical energy storage device has excellent dynamic performance, which can prevent lithium (or sodium, magnesium and zinc) from precipitating under condition of rapid and large current charging, on the other hand, they can ensure that the electrochemical energy storage device has excellent cycle performance.

### DETAILED DESCRIPTION

Hereinafter a negative electrode slurry, a negative electrode plate and an electrochemical energy storage device according to the present disclosure will be described in detail.

Firstly, a negative electrode slurry according to a first aspect of the present disclosure will be described

The negative electrode slurry according to the first aspect of the present disclosure comprises a solvent and a solid component dispersed in the solvent. The solid component comprises a negative electrode active material, a water-soluble binder and a dispersant. The negative electrode active material comprises a carbon-type active material. The dispersant comprises an A dispersant and a B dispersant, the A dispersant is a cellulose-type dispersant, the B dispersant is at least one of poly(acrylic acid)-type dispersant, polyacrylate-type dispersant and polyacrylamide-type dispersant.

In the negative electrode slurry according to the first aspect of the present disclosure, in a first charged-discharged cycle process of the electrochemical energy storage device, reaction will occur on a liquid-solid interface between the negative electrode active material and an electrolyte, and a passive film, that is SEI film (solid electrolyte interface film), will be formed and coated on a surface of the negative electrode active material. Formation of the SEI film has a crucial impact on performance of the negative electrode active material. On one hand, the formation of the SEI film consumes some metal ions and increases irreversible capacity of the first charged-discharged cycle process of the electrochemical energy storage device, thereby decreasing charging-discharging efficiency of the negative electrode active material; on the other hand, the SEI film is solvent insoluble and can stably exist in the electrolyte, also solvent molecules cannot pass through the passive film (SEI film), thus can effectively prevent the solvent molecules from co-intercalating and avoid damaging the negative electrode active material due to the co-intercalation of the solvent molecules, therefore cycle performance and service life of the electrochemical energy storage device can be greatly improved. In the charged-discharged cycle process of the electrochemical energy storage device, if the SEI film is unstable, continuous reaction will occur between the exposed negative electrode active material and the electrolyte when the SEI film is destroyed, and a new SEI film will be formed, which will continuously consume the metal ions and the solvent of the electrolyte, thereby decreasing conduction velocity of the metal ions and greatly decreasing cycle performance of the electrochemical energy storage device.

The negative electrode slurry according to the present disclosure comprises the negative electrode active material comprising the carbon-type active material, the A dispersant and the B dispersant. Binding force between the A dispersant and the carbon-type active material is greater than binding force between the B dispersant and the carbon-type active material, and dispersibility of the B dispersant dispersed in the solvent is superior to dispersibility of the A dispersant dispersed in the solvent. Therefore, the A dispersant can form a protective film on the surface of the carbon-type active material, the A dispersant (such as sodium carboxymethylcellulose) on the surface of the carbon-type active material can effectively improve surface roughness of the carbon-type active material, and is beneficial to form a stable SEI film. The main reason is that: when the B dispersant (such as polyacrylate) is used alone, an unstable carboxylate formed by the B dispersant and the electrolyte salt will be left on the SEI film, because the SEI film containing the component of carboxylate is unstable, cycle performance of the electrochemical energy storage device is poor, even may dive, however the carbon-type active material with the A dispersant protecting the surface thereof can effectively avoid above problem, therefore it can improve cycle performance of the electrochemical energy storage device and prevent the electrochemical energy storage device from diving too early. In addition, the B dispersant (such as polyacrylate) can also make the dispersing of the negative electrode slurry uniform, which is beneficial to prepare the negative electrode plate, and the B dispersant can improve dynamic performance (such as rate capability, precipitation lithium and the like) of the electrochemical energy storage device. For example, for the polyacrylate, its oxygen of carboxyl has large electronegativity and good ion endophilicity to the metal ions of the electrolyte, which is beneficial to the conduction of the metal ions, and is beneficial to improve charging-discharging performance under large rate capability of the electrochemical energy storage device.

In the negative electrode slurry according to the first aspect of the present disclosure, if the B dispersant is used to disperse the negative electrode active material alone, an unstable SEI film will be formed on the surface of the negative electrode active material. When charged-discharged cycle process is performed, the SEI film is destroyed, continuous reaction will occur between exposed negative electrode active material and the electrolyte and a new SEI film will be formed, in this way the SEI film is repeatedly destroyed and then regenerated, continuously consumes the metal ions and the solvent of the electrolyte, thereby reducing conduction velocity of the metal ions. Therefore, when charged-discharged cycle process of the electrochemical energy storage device is preformed, capacity retention rate will be continuously deteriorated, and the electrochemical energy storage device will dive too early. If the A dispersant is used to disperse the negative electrode active material alone, when a content of the A dispersant is too low, the negative electrode active material cannot be effectively dispersed, when the content of the A dispersant is too high, the negative electrode active material is coated too thick, which is not beneficial to intercalation and deintercalation of the metal ions, and will deteriorate dynamic performance of the electrochemical energy storage device. Under a combined effect of the A dispersant and the B dispersant, on one hand, it can ensure that the electrochemical energy storage device has excellent dynamic performance, which can prevent lithium from precipitating under rapid and large current charging condition, on the other hand, it can ensure that the electrochemical energy storage device has excellent cycle performance.

In the negative electrode slurry according to the first aspect of the present disclosure, specifically, the A dispersant is at least one selected from a group consisting of sodium carboxymethylcellulose, carboxymethylcellulose, methylcellulose, ethylcellulose, methylol cellulose and hydroxypropyl cellulose. Preferably, the A dispersant is selected from sodium carboxymethylcellulose.

In the negative electrode slurry according to the first aspect of the present disclosure, specifically, the B dispersant is at least one selected from a group consisting of poly(acrylic acid), poly(methacrylic acid), sodium polyacrylate, sodium polymethacrylate, potassium polyacrylate, polypotassium methacrylate, lithium polyacrylate, lithium polymethacrylate, polyacrylamide and polymethacrylamide. Preferably, the B dispersant is at least one selected from a group consisting of sodium polyacrylate, sodium polymethacrylate, lithium polyacrylate and lithium polymethacrylate.

In the negative electrode slurry according to the first aspect of the present disclosure, the water-soluble binder is at least one selected from a group consisting of styrene-butadiene latex, styrene-acrylic latex, polyacrylate, polyacrylate copolymer, polymethacrylate, poly(vinyl alcohol), polyurethane, polyacrylamide and acrylic acid and acrylonitrile copolymer.

In the negative electrode slurry according to the first aspect of the present disclosure, the carbon-type active material is at least one selected from a group consisting of artificial graphite, natural graphite, soft carbon and hard carbon. Preferably, the carbon-type active material comprises artificial graphite or natural graphite.

In the negative electrode slurry according to the first aspect of the present disclosure, the negative electrode active material may further comprise at least one selected from a group consisting of silicon-type active material, tin-type active material and lithium titanate.

In the negative electrode slurry according to the first aspect of the present disclosure, a content of the carbon-type active material is not less than 90% of a total mass of the negative electrode active material. For example, when the negative electrode active material comprises the carbon-type active material and the silicon-type active material, the content of the carbon-type active material is not less than 90% of the total mass of the negative electrode active material. This is because that volume expansion of silicon-type active material during charged-discharged cycle process is too large, so it is easy to pulverize, when the content of the silicon-type active material content is too high, during the charged-discharged cycle process, the A dispersant cannot form a better coating layer on the surface of the negative electrode active material, thereby affecting improvement of performance of the electrochemical energy storage device.

In the negative electrode slurry according to the first aspect of the present disclosure, preferably, an average distribution concentration of the A dispersant on the surface of the negative electrode active material is higher than an average distribution concentration of the A dispersant in the negative electrode slurry. Further preferably, the A dispersant forms a coating layer on the surface of the negative electrode active material.

In the negative electrode slurry according to the first aspect of the present disclosure, a way by which the average distribution concentration of the A dispersant on the surface of the negative electrode active material is higher than the average distribution concentration of the A dispersant in the negative electrode slurry is not particularly limited and may be selected as actual demand, specifically, it can be achieved in the following ways: the first method: under a situation of adding an appropriate amount of the solvent, firstly the A dispersant, a small amount of the B dispersant and the negative electrode active material are mixed together, then an appropriate amount of the solvent, the water-soluble binder and a rest amount of the B dispersant are added and stirred to disperse uniformly; the second method: under a situation of not adding the solvent, firstly the A dispersant and the negative electrode active material are dry-mixed together, then the solvent, the water-soluble binder and the B dispersant are added and stirred to disperse uniformly; the third method: under a situation of adding an appropriate amount of solvent, firstly the A dispersant and the negative electrode active material are mixed, then an appropriate amount of the solvent, the water-soluble binder and the B dispersant are added and stirs to disperse uniformly. Preferably, the third method is adopted in the present disclosure. Firstly, the A dispersant coats the surface of the negative electrode active material, then the B dispersant is used to disperse the negative electrode active material coated with the A dispersant, this can effectively avoid the above-mentioned problems when using the A dispersant or the B dispersant alone, and make the electrochemical energy storage device have excellent dynamic performance and cycle performance.

In the negative electrode slurry according to the first aspect of the present disclosure, if a content of the A dispersant is too low, the A dispersant cannot uniformly coat the surface of the negative electrode active material, so it has an limited effect on increasing stability of the SEI film, if the content of the A dispersant is too high, the A dispersant coating the surface of the negative electrode active material is too much, which is not beneficial to intercalation and deintercalation of the metal ions, so it can deteriorate dynamic performance of the electrochemical energy storage device. Preferably, the content of the A dispersant is 0.2%˜1.5% of a total mass of the solid component, further preferably, the content of the A dispersant is 0.5%˜1% of the total mass of the solid component.

In the negative electrode slurry according to the first aspect of the present disclosure, if the content of the B dispersant is too high, some of the B dispersant will coat the surface of the negative electrode active material, the carboxylate will be formed by the B dispersant coating the surface of the negative electrode active material and the electrolyte and will be left on the SEI film, this results in that this part of the SEI film is unstable, if the content of the B dispersant is too low, dynamic performance of the electrochemical energy storage device is poor, which is not beneficial to rapid charging with large rate capability of the electrochemical energy storage device. Preferably, the content of the B dispersant is 0.5%˜1.8% of the total mass of the solid component; further preferably, the content of the B dispersant is 0.5%˜1% of the total mass of the solid component.

In the negative electrode slurry according to the first aspect of the present disclosure, a combined effect of the A dispersant and B dispersant can improve dynamic performance and cycle performance of the electrochemical energy storage device, it should be noted that, changes of the contents of the A dispersant and the B dispersant will directly influence electrochemical performance of the electrochemical energy storage device, if the contents are beyond the above range, relevant performance of the electrochemical energy storage device must be influenced, but for some non-restrict requirements, they can also improve dynamic performance and cycle performance of the electrochemical energy storage device to a certain extent.

In the negative electrode slurry according to the first aspect of the present disclosure, a content of the water-soluble binder is 0.5%˜3% of the total mass of the solid component, preferably, the content of the water-soluble binder is 1%˜2% of the total mass of the solid component.

In the negative electrode slurry according to the first aspect of the present disclosure, a sum of the content of the water-soluble binder and the content of the dispersant (the content of the dispersant means the sum of a mass of A dispersant and a mass of the B dispersant) is not greater than 5% of the total mass of the solid component of the negative electrode slurry. This is because, if the sum of the content of the water-soluble binder and the content of the dispersant is too high, the content of the negative electrode active material will be too low, which will decrease capacity of the electrochemical energy storage device. At the same time, when the sum of the content of the water-soluble binder and the content of the dispersant is a constant value, if the content of the water-soluble binder content is too high, then the content of the dispersant is too low, dispersion effect of the negative electrode slurry is poor; if the content of the water-soluble binder is too low, bond force of the negative electrode active material on the negative electrode current collector is insufficient, resulting in carbon-type active material falling off from the negative electrode plate, which will influence performance of the electrochemical energy storage device. Preferably, a mass ratio of the water-soluble binder and the dispersant is 1:1˜2:1.

In the negative electrode slurry according to the first aspect of the present disclosure, the solid component may further comprise a conductive agent. A type of the conductive agent is not particularly limited and may be selected as actual demand, specifically, the conductive agent is one or more selected from a group consisting of conductive carbon black, conductive carbon nanotube, conductive fiber and acetylene black. A content of the conductive agent is not particularly limited and may be selected as actual demand, preferably, a content of the conductive agent is not greater than 4% of the total mass of the solid component, further preferably, the content of the conductive agent is 0.5%˜2% of the total mass of the solid component.

In the negative electrode slurry according to the first aspect of the present disclosure, a ratio of a particle size D50 of the negative electrode slurry and a particle size D50 of the negative electrode active material is not higher than 1.2:1, if the ratio is higher than this value (that is 1.2:1), when the negative electrode slurry is coated on the surface the negative electrode current collector, particles will appear on the surface of the negative electrode plate and influence the quality of the negative electrode plate, thus influence performance of the electrochemical energy storage device.

In the negative electrode slurry according to the first aspect of the present disclosure, if the coating layer formed by the A dispersant on the surface of the negative electrode active material is too thick, it will influence deintercalation rate of the metal ions in the coating layer, and in turn influence charging capability, if the coating layer is too thin, the negative electrode active material surface is easy to directly contact the B dispersant, so as to influence stability of the SEI film, preferably, a thickness of the coating layer is 1 nm˜100 nm, further preferably, the thickness of the coating layer is 10 nm˜50 nm.

In the negative electrode slurry according to the first aspect of the present disclosure, the solvent is selected from deionized water.

Secondly, a negative electrode plate according to a second aspect of the present disclosure is described.

The negative electrode plate according to the second aspect of the present disclosure comprises a negative electrode current collector and a negative electrode active material layer provided on a surface of the negative electrode current collector. The negative electrode active material layer is formed by that the negative electrode slurry according to the first aspect of the present disclosure is coated on the negative electrode current collector and then dried. That is, the negative electrode active material layer comprises the solid component as mentioned above due to evaporation of the solvent of the negative electrode slurry by drying.

In the negative electrode plate according to the second aspect of the present disclosure, a type of the negative electrode current collector is not particularly limited and may be selected as actual demand. Preferably, the negative electrode current collector is selected from copper foil or stainless steel foil.

In the negative electrode plate according to the second aspect of the present disclosure, a drying process of the negative electrode slurry is not particularly limited and may be selected according to actual demand.

Thirdly, an electrochemical energy storage device according to a third aspect of the present disclosure is described.

The electrochemical energy storage device according to the third aspect of the present disclosure comprises the negative electrode plate according to the second aspect of the present disclosure.

In the electrochemical energy storage device according to the third aspect of the present disclosure, it should be noted that, the electrochemical energy storage device may be a lithium-ion battery, a sodium-ion battery or a supercapacitor. In the examples of the present disclosure, the described electrochemical energy storage device is a lithium-ion battery, but the present disclosure is not limited to this.

In the electrochemical energy storage device according to the third aspect of the present disclosure, the electrochemical energy storage device further comprises a positive electrode plate, an electrolyte, a separator and a package case.

In the lithium-ion battery, a positive electrode active material of the positive electrode plate is selected from materials which can intercalate and deintercalate lithium ions, specifically, the positive electrode active material is selected from lithium transition metal composite oxide, preferably, the positive electrode active material is selected from a group consisting of lithium cobalt oxide, lithium nickel oxide, lithium manganese oxide, lithium nickel manganese oxide, lithium nickel cobalt manganese oxide, lithium nickel cobalt aluminum oxide and compounds obtained by adding other transition metals or non-transition metals to the above oxides.

In the lithium-ion battery, the electrolyte is a liquid electrolyte, the electrolyte comprises a lithium salt and a non-aqueous organic solvent, a type of the electrolyte is not particularly limited, and as long as normal transport of metal ions can be guaranteed.

In the lithium-ion battery, a type of the separator is not particularly limited and may be selected according to the actual demand, specifically, the separator is selected from a group consisting of a polyethylene film, a polypropylene film, a polyvinylidene fluoride film and a multilayer composite film thereof.

Hereinafter the present disclosure will be described in detail in combination with examples. It should be noted that, the examples described in the present disclosure are only used for explaining the present disclosure, and are not intended to limit the present disclosure. In the examples, the described electrochemical energy storage device is a lithium-ion secondary battery, but the present disclosure is not limited to this.

In the following example, the reagents, materials and instruments used are commercially available unless otherwise specified.

### Example 1

(1) Preparation of a positive electrode plate: LiCoO₂ (positive electrode active material), acetylene black (conductive agent), polyvinylidene fluoride (binder) at a weight ratio of 97:1.4:1.6 were fully stirred and uniformly mixed with N-methyl-2-pyrrolidone (solvent) to obtain a positive electrode slurry, then the positive electrode slurry was uniformly coated on an aluminum foil (positive electrode current collector) with a thickness of 14 μm, drying was then performed, which was followed by cold-pressing, after edge-trimming, slicing, slitting, a positive electrode plate was obtained.

(2) Preparation of a negative electrode plate: artificial graphite (negative electrode active material), conductive carbon black (conductive agent) and sodium carboxymethylcellulose (A dispersant) were kneaded in deionized water (solvent) to make a surface of the artificial graphite coated with a layer of sodium carboxymethylcellulose, then sodium polyacrylate (B dispersant) and styrene-butadiene latex (water-soluble binder) were added in, after fully stirred and uniformly mixed, a negative electrode slurry was obtained, where, a mass ratio of the artificial graphite, the conductive carbon black, the styrene-butadiene latex, the sodium carboxymethylcellulose and the sodium polyacrylate was 95:1:2:0.2:1.8, next the negative electrode slurry was uniformly coated on a copper foil (negative electrode current collector) with a thickness of 8 μm, drying was then performed, which was followed by cold-pressing, after edge-trimming, slicing, slitting, a negative electrode plate was obtained.

(3) Preparation of a separator: a polyethylene film (PE) was used as a separator.

(4) Preparation of an electrolyte: ethylene carbonate (EC), ethylmethyl carbonate (EMC), diethyl carbonate (DEC) at a volume ratio of 1:1:1 were mixed to obtain a non-aqueous organic solvent, then LiPF6 was added in, after uniformly mixed, preparation of the electrolyte was finished, where, a content of LiPF₆ was 12.5% of the total mass of the electrolyte.

(5) Preparation of a lithium-ion battery: the positive electrode plate, the separator and the negative electrode plate were laminated in order so as to make the separator positioned between the positive electrode plate and the negative electrode plate and separate the positive electrode plate and the negative electrode plate, then were wound to form an electrode assembly and placed in a package case, next the electrolyte was injected into and the package case was packaged, the lithium-ion battery was obtained.

### Example 2

The preparation was the same as example 1, except that in the preparation of a negative electrode plate (step (2)), in the negative electrode slurry, the mass ratio of the artificial graphite, the conductive carbon black, the styrene-butadiene latex, the sodium carboxymethylcellulose and the sodium polyacrylate was 95:1:2:1.5:0.5.

### Example 3

The preparation was the same as example 1, except that in the preparation of a negative electrode plate (step (2)), in the negative electrode slurry, the mass ratio of the artificial graphite, the conductive carbon black, the styrene-butadiene latex, the sodium carboxymethylcellulose and the sodium polyacrylate was 95:1:2:0.5:1.5.

### Example 4

The preparation was the same as example 1, except that in the preparation of a negative electrode plate (step (2)), in the negative electrode slurry, the mass ratio of the artificial graphite, the conductive carbon black, the styrene-butadiene latex, the sodium carboxymethylcellulose and the sodium polyacrylate was 95:1:2:1:1.

### Comparative Example 1

The preparation was the same as example 1, except that in the preparation of a negative electrode plate (step (2)), artificial graphite (negative electrode active material), carbon black (conductive agent conductive) and sodium carboxymethylcellulose (A dispersant) were kneaded in deionized water (solvent) to make a surface of the artificial graphite coated with a layer of sodium carboxymethylcellulose, then styrene-butadiene latex (water-soluble binder) was added in, after fully stirred and uniformly mixed, a negative electrode slurry was obtained, where, the mass ratio of the artificial graphite, the conductive carbon black, the styrene-butadiene latex and the sodium carboxymethylcellulose was 95:1:2:2, next the negative electrode slurry was uniformly coated on a copper foil (negative electrode current collector) with a thickness of 8 μm, drying was then performed, which was followed by cold-pressing, after edge-trimming, slicing, slitting, a negative electrode plate was obtained.

### Comparative Example 2

The preparation was the same as example 1, except that in the preparation of a negative electrode plate (step (2)), artificial graphite (negative electrode active material), carbon black (conductive agent conductive) and sodium polyacrylate (A dispersant) were kneaded in deionized water (solvent) to make a surface of the artificial graphite coated with a layer of sodium polyacrylate, then styrene-butadiene latex (water-soluble binder) was added in, after fully stirred and uniformly mixed, a negative electrode slurry was obtained, where, the mass ratio of the artificial graphite, the conductive carbon black, the styrene-butadiene latex and the sodium polyacrylate is 95:1:2:2, next the negative electrode slurry was uniformly coated on a copper foil (negative electrode current collector) with a thickness of 8 μm, drying was then performed, which was followed by cold-pressing, after edge-trimming, slicing, slitting, a negative electrode plate was obtained.

### Comparative Example 3

The preparation was the same as example 1, except that in the preparation of a negative electrode plate (step (2)), artificial graphite (negative electrode active material), carbon black (conductive agent conductive) and sodium polyacrylate (A dispersant) were kneaded in deionized water (solvent) to make a surface of the artificial graphite coated with a layer of sodium polyacrylate, then styrene-butadiene latex (water-soluble binder) and sodium carboxymethylcellulose (B dispersant) were added in, after fully stirred and uniformly mixed, a negative electrode slurry was obtained, wherein, the mass ratio of the artificial graphite, the conductive carbon black, the styrene-butadiene latex, the sodium carboxymethylcellulose and the sodium polyacrylate is 95:1:2:0.2:1.8, next the negative electrode slurry was uniformly coated on a copper foil (negative electrode current collector) with a thickness of 8 μm, drying was then performed, which was followed by cold-pressing, after edge-trimming, slicing, slitting, a negative electrode plate was obtained.

### Comparative Example 4

The preparation was the same as example 1, except that in the preparation of a negative electrode plate (step (2)): artificial graphite (negative electrode active material), conductive carbon black (conductive agent) and sodium polyacrylate (A dispersant) were kneaded in deionized water (solvent) to make a surface of the artificial graphite coated with a layer of sodium polyacrylate, then styrene-butadiene latex (water-soluble binder) and sodium carboxymethylcellulose (B dispersant) were added in, after fully stirred and uniformly mixed, a negative electrode slurry was obtained, where, the mass ratio of the artificial graphite, the conductive carbon black, the styrene-butadiene latex, the sodium carboxymethylcellulose and the sodium polyacrylate was 95:1:2:1.5:0.5, next the negative electrode slurry was uniformly coated on a copper foil (negative electrode current collector) with a thickness of 8 μm, drying was then performed, which was followed by cold-pressing, after edge-trimming, slicing, slitting, a negative electrode plate was obtained.

### Comparative Example 5

The preparation was the same as example 1, except that in the preparation of a negative electrode plate (step (2)): artificial graphite (negative electrode active material), conductive carbon black (conductive agent) and sodium polyacrylate (A dispersant) were kneaded in deionized water (solvent) to make a surface of the artificial graphite coated with a layer of sodium polyacrylate, then styrene-butadiene latex (water-soluble binder) and sodium carboxymethylcellulose (B dispersant) were added in, after fully stirred and uniformly mixed, a negative electrode slurry was obtained, where, the mass ratio of the artificial graphite, the conductive carbon black, the styrene-butadiene latex, the sodium carboxymethylcellulose and the sodium polyacrylate was 95:1:2:1:1, next the negative electrode slurry was uniformly coated on a copper foil (negative electrode current collector) with a thickness of 8 μm, drying was then performed, which was followed by cold-pressing, after edge-trimming, slicing, slitting, a negative electrode plate was obtained.

### Comparative Example 6

The preparation was the same as example 1, except that in the preparation of a negative electrode plate (step (2)): in the negative electrode slurry, the mass ratio of the artificial graphite, the conductive carbon black, the styrene-butadiene latex, the sodium carboxymethylcellulose and the sodium polyacrylate was 95.9:1:2:0.1:1.

### Comparative Example 7

The preparation was the same as example 1, except that in the preparation of a negative electrode plate (step (2)): in the negative electrode slurry, the mass ratio of the artificial graphite, the conductive carbon black, the styrene-butadiene latex, the sodium carboxymethylcellulose and the sodium polyacrylate was 94:1:2:2:1.

### Comparative Example 8

The preparation was the same as example 1, except that in the preparation of a negative electrode plate (step (2)): in the negative electrode slurry, the mass ratio of the artificial graphite, the conductive carbon black, the styrene-butadiene latex, the sodium carboxymethylcellulose and the sodium polyacrylate was 95.8:1:2:1:0.2.

### Comparative Example 9

The preparation was the same as example 1, except that in the preparation of a negative electrode plate (step (2)): in the negative electrode slurry, the mass ratio of the artificial graphite, the conductive carbon black, the styrene-butadiene latex, the sodium carboxymethylcellulose and the sodium polyacrylate was 94:1:2:1:2.

Finally, test processes and test results of the lithium-ion batteries were described.

(1) Test of Rapid Charging Performance of the Lithium-Ion Battery

Five lithium-ion batteries were tested in each group. At 25° C., the lithium-ion battery was discharged to voltage of 3V at a constant current of 0.5 C, then rapid charging test was started. Process of the rapid charging test was: the lithium-ion battery was charged to voltage of 4.4V at a constant current of 2 C (that was a current value of fully charged to theoretical capacity in 0.5 h), then the lithium-ion battery was charged to a current of 0.05 C at a constant voltage of 4.4V, total capacity of constant current charging process of the lithium-ion battery was marked as CC, a total capacity of constant voltage charging process of the lithium-ion battery was marked as CV.

Capacity retention rate η of constant current charging process of the lithium-ion battery=CC/(CC+CV)×100%.

(2) Cycle Performance Test of the Lithium-Ion Battery

Five lithium-ion batteries were tested in each group. At 25° C., the lithium-ion battery was discharged to voltage of 3V at a constant current of 0.5 C, then cycle test was started. Process of the cycle test was: the lithium-ion battery was charged to voltage of 4.4V at a constant current of 2 C (that was current value of fully charged to theoretical capacity in 0.5 h), then the lithium-ion battery was charged to current of 0.05 C at a constant voltage of 4.4V, next the lithium-ion battery was discharged to voltage of 3V at a constant current of 1 C, this was the first cycle process of the lithium-ion battery, charged capacity and discharged capacity of the first cycle process of the lithium-ion battery were marked. Then the above charged-discharged cycle process of the lithium-ion battery was performed again, charged capacity of 200^{th} cycle and discharged capacity of 200^{th} cycle were marked. Capacity retention rate of the first cycle process of the lithium-ion battery was set as correction coefficient K. Where, K=(discharged capacity of first cycle/charged capacity of first cycle)×100%.

Capacity retention rate ε after 200^{th} cycle under 25° C. of the lithium-ion battery=(discharged capacity of 200^{th} cycle of the lithium-ion battery/charged capacity of 200^{th} cycle of the lithium-ion battery)×K×100%.

TABLE 1
Parameters of examples 1-4 and comparative examples 1-9

| | Dispersant coated on the on surface of the carbon-type | | | | |
|---|---|---|---|---|---|
| | active material | | | | |
| | | | Thickness | | |
| | | | of coating | Dispersant dispersed at other place | |
| | Type | Content | layer/nm | Type | Content |
| Example 1 | sodium | 0.2% | 1 | sodium polyacrylate | 1.8% |
| | carboxymethylcellulose | | | | |
| Example 2 | sodium | 1.5% | 100 | sodium polyacrylate | 0.5% |
| | carboxymethylcellulose | | | | |
| Example 3 | sodium | 0.5% | 10 | sodium polyacrylate | 1.5% |
| | carboxymethylcellulose | | | | |
| Example 4 | sodium | 1.0% | 50 | sodium polyacrylate | 1.0% |
| | carboxymethylcellulose | | | | |
| Comparative | sodium | 2.0% | 200 | / | / |
| example 1 | carboxymethylcellulose | | | | |
| Comparative | sodium polyacrylate | 2.0% | 150 | / | / |
| example 2 | | | | | |
| Comparative | sodium polyacrylate | 1.8% | 100 | sodium | 0.2% |
| example 3 | | | | carboxymethylcellulose | |
| Comparative | sodium polyacrylate | 0.5% | 5 | sodium | 1.5% |
| example 4 | | | | carboxymethylcellulose | |
| Comparative | sodium polyacrylate | 1.0% | 40 | sodium | 1.0% |
| example 5 | | | | carboxymethylcellulose | |
| Comparative | sodium | 0.1% | 0.4 | sodium polyacrylate | 1.0% |
| example 6 | carboxymethylcellulose | | | | |
| Comparative | sodium | 2.0% | 180 | sodium polyacrylate | 1.0% |
| example 7 | carboxymethylcellulose | | | | |
| Comparative | sodium | 1.0% | 5 | sodium polyacrylate | 0.2% |
| example 8 | carboxymethylcellulose | | | | |
| Comparative | sodium | 1.0% | 110 | sodium polyacrylate | 2.0% |
| example 9 | carboxymethylcellulose | | | | |

TABLE 2
Test result of examples 1-4 and comparative examples 1-9

| | η | ϵ |
|---|---|---|
| Example 1 | 65% | 75% |
| Example 2 | 59% | 84% |
| Example 3 | 68% | 92% |
| Example 4 | 62% | 93% |
| Compamtive example 1 | 55% | 86% |
| Compamtive example 2 | 68% | 65% |
| Compamtive example 3 | 66% | 68% |
| Compamtive example 4 | 60% | 72% |
| Compamtive example 5 | 63% | 78% |
| Compamtive example 6 | 67% | 70% |
| Compamtive example 7 | 60% | 78% |
| Compamtive example 8 | 58% | 82% |
| Compamtive example 9 | 62% | 67% |

It could be analyzed from the results in table 2, in examples 1-4 and comparative examples 1-5, for sake of convenience, the sum of the content of the sodium carboxymethylcellulose and the content of the sodium polyacrylate was controlled to be 2% of the total mass of the solid component of the negative electrode slurry. In comparative example 1, the sodium carboxymethylcellulose coated the surface of the negative electrode active material alone, capacity retention rate ε after 200^{th} cycle under 25° C. of the lithium-ion battery was high, but capacity retention rate η of constant current charging process of the lithium-ion battery was low. This was because when the sodium carboxymethylcellulose was used alone, the content of the sodium carboxymethylcellulose on the surface of the negative electrode active material was too much and the coating layer was too thick, which was not beneficial to lithium ion transport, during charging process, some lithium ions could not intercalate into the negative electrode active material, and would be precipitated on the surface of the negative electrode active material, which would become irreversible dead lithium and deteriorate capacity retention rate ε after 200^{th} cycle under 25° C. of the lithium-ion battery to a certain extent, that was cycle performance of the lithium-ion was deteriorated, at the same time too much sodium carboxymethylcellulose coated the surface of the negative electrode active material would also increase internal polarization of the lithium-ion battery, thus capacity retention rate η of constant current charging process of the lithium-ion battery was decreased, which was not beneficial to rapid charging of the lithium-ion battery and not beneficial to dynamic performance of the lithium-ion battery. In comparative example 2, when the sodium polyacrylate coated the surface of the negative electrode active material alone, lithium ion conduction was facilitated, advantage of constant current charging of the lithium-ion battery was increased and charging time was effectively shortened, but capacity retention rate ε after 200^{th} cycle under 25° C. was decreased too rapidly, which resulted in a reduction of service life of the lithium-ion battery.

It could be analyzed in comparative examples 3-5, the sodium carboxymethylcellulose and the sodium polyacrylate were used in a combination way, but the sodium polyacrylate was preferential used to knead the negative electrode active material, then the sodium carboxymethylcellulose was used to disperse the negative electrode active material coated with the sodium polyacrylate, average distribution concentration of the sodium carboxymethylcellulose on the surface of the negative electrode active material was lower than average distribution concentration of the sodium carboxymethylcellulose in the negative electrode slurry, and finally this made capacity retention rate η of constant current charging process of the lithium-ion battery of the lithium-ion battery fluctuate little, but capacity retention rate ε after 200^{th} cycle under 25° C. was decreased more obviously. This was because endophilicity of the sodium polyacrylate and the negative electrode active material were both poor, the sodium carboxymethylcellulose coated the surface of the sodium polyacrylate would weaken direct contact between the sodium polyacrylate and the electrolyte, thus would influence lithium ion transport to a certain extent, and would result in little fluctuation or decrease of capacity retention rate η of constant current charging process of the lithium-ion battery of the lithium-ion battery. In addition, compared with the sodium carboxymethylcellulose, endophilicity of the sodium polyacrylate and the negative electrode active material were poor, that sodium polyacrylate was used to knead the negative electrode active material could not effectively improve surface roughness of the artificial graphite, at the same time lithium carboxylate formed by the sodium polyacrylate and the electrolyte would be left on the SEI film on the surface of the negative electrode active material, and made the SEI film unstable, when the SEI film was destroyed in charged-discharged cycle process of the lithium-ion battery, a new SEI film was repeatedly formed, this would continuously consume the lithium ions and the solvent of the electrolyte and decrease velocity of the lithium ion conduction, therefore capacity retention rate ε after 200^{th} cycle under 25° C. was decreased more obviously and service life of the lithium-ion battery was shortened.

In examples 1-4, the sodium carboxymethylcellulose was preferential used to knead the negative electrode active material, then the sodium polyacrylate was used to disperse the negative electrode active material coated with the sodium carboxymethylcellulose, average distribution concentration of the sodium carboxymethylcellulose on the surface of the negative electrode active material was higher than average distribution concentration of the sodium carboxymethylcellulose in the negative electrode slurry, capacity retention rate η of constant current charging process of the lithium-ion battery and capacity retention rate ε after 200^{th} cycle under 25° C. of the lithium-ion battery were both high. This was because sodium carboxymethylcellulose was preferential used to knead the negative electrode active material, the sodium carboxymethylcellulose could preferential coat the surface of the negative electrode active material and effectively improve surface roughness of the negative electrode active material, which made the SEI film more stable, thus ensured that the lithium ion conduction worked properly, at the same time endophilicity of the sodium polyacrylate of the negative electrode slurry for the electrolyte was more better, which could further improve lithium ion conduction and make lithium ion more smoothly intercalate and deintercalate of the negative electrode active material of charged-discharged cycle process of the lithium-ion battery, and effectively improve charging efficiency and capacity retention rate ε after 200^{th} cycle under 25° C. of the lithium-ion battery, that was the dynamic performance and cycle performance of the lithium-ion battery could be improved.

In the comparative example 6, when the content of the sodium carboxymethylcellulose was less than 0.2%, the sodium carboxymethylcellulose could not effectively coat the surface of the negative electrode active material, some exposed negative electrode active material contacted the sodium polyacrylate, in this location the SEI film formed on the surface of the negative electrode active material was unstable, when a new SEI film was continually generated, the electrolyte quickly consumed, which thus resulted in quickly decrease of capacity retention rate ε after 200^{th} cycle under 25° C. of the lithium-ion battery. However in comparative example 7, when the content of the sodium carboxymethylcellulose was greater than 1.5%, the sodium carboxymethylcellulose on the surface of the negative electrode active material was too much, the coating layer formed by the sodium carboxymethylcellulos on the surface of the negative electrode active material was too thick, which was not beneficial to lithium ion transport, during charging process, some lithium ions could not intercalate into the negative electrode active material, which would be precipitated on the surface of the negative electrode active material and became irreversible dead lithium, capacity retention rate ε after 200^{th} cycle under 25° C. of the lithium-ion battery was deteriorated to a certain extent, that is, service life of the lithium-ion battery was deteriorated, polarization of negative electrode of the lithium-ion battery was increased and capacity retention rate η of constant current charging process of the lithium-ion battery of the lithium-ion battery was decreased, which was not beneficial to rapid charging of the lithium-ion battery.

In the comparative example 8,when the content of the sodium polyacrylate was less 0.5%, compared with the lithium-ion battery without adding the sodium polyacrylate, capacity retention rate η of constant current charging process of the lithium-ion battery could be slightly improved. However, improvement of endophilicity for the electrolyte was limited due to less content of the sodium polyacrylate, polarization of negative electrode of the lithium-ion battery was still large, therefore capacity retention rate η of constant current charging process of the lithium-ion battery was still low. However in comparative example 9, the content sodium carboxymethylcellulose which was used to knead was moderated, when the content of the sodium polyacrylate was greater than 1.8%, sodium polyacrylate as the dispersant at this time was too much, this made rebound of the negative electrode plate of the negative electrode slurry preparation during lithium-ion battery charged-discharged cycle process increase, which would deteriorate internal contact interface of the lithium-ion battery, thus increased polarization of the negative electrode. Therefore, capacity retention rate η of constant current charging process of the lithium-ion battery and capacity retention rate after 200^{th} charging-discharging cycle of the lithium-ion battery were both low. In addition, the increase of content of dispersant would result in decrease of content of the negative electrode active material, this would indirectly decrease energy density of the lithium-ion battery. Unstable organic lithium carboxylate would be formed due to excess of the sodium polyacrylate and the lithium salt, would be left on the surface of the negative electrode and destroy the SEI film to a certain extent, thus new SEI film would be repeatedly regenerated during continually consume lithium ion of the electrolyte and decreased lithium ion conduction, thus resulted in decrease of capacity retention rate ε after 200^{th} cycle under 25° C. of the lithium-ion battery.

Therefore when the content of the sodium carboxymethylcellulose was 0.2%˜1.5% and the content of the sodium polyacrylate was 0.5%˜1.8%, the thickness of the coating layer of the sodium carboxymethylcellulose on the surface of the negative electrode active material was moderate, electrochemical performance of the lithium-ion battery was excellent, and when the content of the sodium carboxymethylcellulose was 0.5%˜1% and the content of the sodium polyacrylate 0.5%˜1%, thickness of the coating layer of the sodium carboxymethylcellulose on the surface of the negative electrode active material was 10 nm˜50 nm, electrochemical performance of the lithium-ion battery was more excellent.

What is claimed:

1. A negative electrode slurry, comprising a solvent and a solid component dispersed in the solvent, the solid component comprising:
a negative electrode active material;
a water-soluble binder; and
a dispersant;
wherein
the negative electrode active material comprises a carbon-type active material;
the dispersant comprises an A dispersant and a B dispersant, the A dispersant is a cellulose-type dispersant, the B dispersant is at least one of poly(acrylic acid)-type dispersant, polyacrylate-type dispersant and polyacrylamide-type dispersant.

2. The negative electrode slurry according to claim 1, wherein a content of the carbon-type active material is not less than 90% of a total mass of the negative electrode active material.

3. The negative electrode slurry according to claim 2, wherein an average distribution concentration of the A dispersant on the surface of the negative electrode active material is higher than an average distribution concentration of the A dispersant in the negative electrode slurry.

4. The negative electrode slurry according to claim 1, wherein
the A dispersant is at least one selected from a group consisting of sodium carboxymethylcellulose, carboxymethylcellulose, methylcellulose, ethylcellulose, methylol cellulose and hydroxypropyl cellulose;
the B dispersant is at least one selected from a group consisting of poly(acrylic acid), poly(methacrylic acid), sodium polyacrylate, sodium polymethacrylate, potassium polyacrylate, polypotassium methacrylate, lithium polyacrylate, lithium polymethacrylate, polyacrylamide and polymethacrylamide.

5. The negative electrode slurry according to claim 4, wherein
the A dispersant is selected from sodium carboxymethylcellulose;
the B dispersant is at least one selected from a group consisting of sodium polyacrylate, sodium polymethacrylate, lithium polyacrylate and lithium polymethacrylate.

6. The negative electrode slurry according to claim 1, wherein the water-soluble binder is at least one selected from a group consisting of styrene-butadiene latex, styrene-acrylic latex, polyacrylate, polyacrylate copolymer, polymethacrylate, poly(vinyl alcohol), polyurethane, polyacrylamide and acrylic acid and acrylonitrile copolymer.

7. The negative electrode slurry according to claim 1, wherein
a content of the A dispersant is 0.2%˜1.5% of a total mass of the solid component;
a content of the B dispersant is 0.5%˜1.8% of the total mass of the solid component.

8. The negative electrode slurry according to claim 7, wherein
the content of the A dispersant is 0.5%˜1% of the total mass of the solid component;
the content of the B dispersant is 0.5%˜1% of the total mass of the solid component.

9. The negative electrode slurry according to claim 1, wherein a mass ratio of the water-soluble binder and the dispersant is 1:1˜2:1.

10. The negative electrode slurry according to claim 1, wherein the A dispersant forms a coating layer on a surface of the negative electrode active material, a thickness of the coating layer is 1 nm˜100 nm.

11. The negative electrode slurry according to claim 10, wherein the thickness of the coating layer is 10 nm˜50 nm.

12. A negative electrode plate, comprising a negative electrode current collector and a negative electrode active material layer provided on a surface of the negative electrode current collector;
wherein
the negative electrode active material layer comprises a solid component;
the solid component comprises a negative electrode active material, a water-soluble binder and a dispersant;
the negative electrode active material comprises a carbon-type active material;
the dispersant comprises an A dispersant and a B dispersant, the A dispersant is a cellulose-type dispersant, the B dispersant is at least one of poly(acrylic acid)-type dispersant, polyacrylate-type dispersant and polyacrylamide-type dispersant.

13. The negative electrode plate according to claim 12, wherein a content of the carbon-type active material is not less than 90% of a total mass of the negative electrode active material.

14. The negative electrode plate according to claim 12, wherein
the A dispersant is at least one selected from a group consisting of sodium carboxymethylcellulose, carboxymethylcellulose, methylcellulose, ethylcellulose, methylol cellulose and hydroxypropyl cellulose;
the B dispersant is at least one selected from a group consisting of poly(acrylic acid), poly(methacrylic acid), sodium polyacrylate, sodium polymethacrylate, potassium polyacrylate, polypotassium methacrylate, lithium polyacrylate, lithium polymethacrylate, polyacrylamide and polymethacrylamide.

15. The negative electrode plate according to claim 12, wherein
a content of the A dispersant is 0.2%˜1.5% of a total mass of the solid component;
a content of the B dispersant is 0.5%˜1.8% of the total mass of the solid component.

16. The negative electrode plate according to claim 12, wherein the A dispersant forms a coating layer on a surface of the negative electrode active material, a thickness of the coating layer is 1 nm˜100 nm.

17. An electrochemical energy storage device, comprising a negative electrode plate;
the negative electrode plate comprising a negative electrode current collector and a negative electrode active material layer provided on a surface of the negative electrode current collector;
wherein
the negative electrode active material layer comprises a solid component;
the solid component comprises a negative electrode active material, a water-soluble binder and a dispersant;
the negative electrode active material comprises a carbon-type active material;
the dispersant comprises an A dispersant and a B dispersant, the A dispersant is a cellulose-type dispersant, the B dispersant is at least one of poly(acrylic acid)-type dispersant, polyacrylate-type dispersant and polyacrylamide-type dispersant.

18. The electrochemical energy storage device according to claim 17, wherein
the A dispersant is at least one selected from a group consisting of sodium carboxymethylcellulose, carboxymethylcellulose, methylcellulose, ethylcellulose, methylol cellulose and hydroxypropyl cellulose;
the B dispersant is at least one selected from a group consisting of poly(acrylic acid), poly(methacrylic acid), sodium polyacrylate, sodium polymethacrylate, potassium polyacrylate, polypotassium methacrylate, lithium polyacrylate, lithium polymethacrylate, polyacrylamide and polymethacrylamide.

19. The electrochemical energy storage device according to claim 17, wherein
a content of the A dispersant is 0.2%˜1.5% of a total mass of the solid component;
a content of the B dispersant is 0.5%˜1.8% of the total mass of the solid component.

20. The electrochemical energy storage device according to claim 17, wherein the A dispersant forms a coating layer on a surface of the negative electrode active material, a thickness of the coating layer is 1 nm˜100 nm.
